(19) United States
(12) Patent Application Publication
(10) Pub. No.: US 2023/0326013 A1
(43) Pub. Date: Oct. 12, 2023

(54) METHOD FOR PREDICTING EPIDERMAL GROWTH FACTOR RECEPTOR MUTATIONS IN LUNG ADENOCARCINOMA

(71) Applicants: Taipei Medical University, Taipei City (TW); aetherAI Co., Ltd., Taipei City (TW)

(72) Inventors: CHENG-YU CHEN, Taipei City (TW); CHI-LONG CHEN, Taipei City (TW); CHAO-YUAN YEH, Taoyuan City (TW); CHI-CHUNG CHEN, Taipei City (TW); TZU-HAO CHANG, New Taipei City (TW)

(21) Appl. No.: 17/863,494

(22) Filed: Jul. 13, 2022

(30) Foreign Application Priority Data
Mar. 28, 2022 (TW) 111111648

(51) Int. Cl. G06T 7/00; G06N 3/02

(52) U.S. Cl. CPC G06T 7/0012; G06N 3/02; G06N 7/005

(57) ABSTRACT

A method for predicting epidermal growth factor receptor (EGFR) mutations in lung adenocarcinoma is provided. The method utilizes a lung adenocarcinoma EGFR mutation classification model based on a deep learning model, and performs back-propagation training on the deep learning model by using whole-slide pathological images and corresponding pathological data. The trained lung adenocarcinoma EGFR mutation classification model can determine whether a to-be-classified slide-level image with lung adenocarcinoma features have EGFR mutations.

### CROSS-REFERENCE TO RELATED PATENT APPLICATION

This application claims the benefit of priority to Taiwan Patent Application No. 111111648, filed on Mar. 28, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a prediction method, and more particularly to a method for predicting epidermal growth factor receptor (EGFR) mutations in lung adenocarcinoma.

### BACKGROUND OF THE DISCLOSURE

The presence or absence of EGFR mutation in lung adenocarcinoma has a considerable impact on the medication prescribed by physicians. In existing gene mutation diagnosis methods, the presence or absence of such mutation is mainly determined by gene sequencing or immunohistochemical staining. However, gene sequencing is an expensive process to undertake.

### SUMMARY OF THE DISCLOSURE

In response to the above-referenced technical inadequacies, the present disclosure provides a method for predicting epidermal growth factor receptor (EGFR) mutations in lung adenocarcinoma.

In one aspect, the present provides a method for predicting epidermal growth factor receptor (EGFR) mutations in lung adenocarcinoma, the method includes: obtaining a plurality of whole-slide pathological images, each including lung adenocarcinoma features; obtaining a plurality of pathological data records corresponding to the whole-slide pathological images, respectively, wherein the pathological data records respectively describe whether the corresponding whole-slide pathological images have EGFR mutations; dividing the whole-slide pathological images and the pathological data records into a training set and a test set; performing a data augmentation process on the training set to obtain an augmented training set; establishing a lung adenocarcinoma EGFR mutation classification model based on a deep learning model, wherein the deep learning model includes a convolutional layer, a pooling layer, a normalization layer, a global pooling layer and a fully-connected Layer; inputting the augmented training set into the deep learning model and performing a back-propagation training to utilize an optimization algorithm to optimize a loss function by training the deep learning model with a plurality of iterations, wherein, when a convergence condition is met, a trained lung adenocarcinoma EGFR mutation classification model is obtained; obtaining a to-be-classified slide-level image including lung adenocarcinoma features; and inputting the to-be-classified slide-level image into the trained lung adenocarcinoma EGFR mutation classification model to obtain a prediction result for determining whether the to-be-classified slide-level image has EGFR mutations.

Therefore, in the method for predicting epidermal growth factor receptor mutations in lung adenocarcinoma provided by the present disclosure, an indicator that can predict whether EGFR mutations are present or absent in lung adenocarcinoma is provided, such as to allow for a more accurate opinion on whether or not to perform gene sequencing, thus saving resources and improving sensitivity.

Moreover, in the method for predicting the EGFR mutations in lung adenocarcinoma provided by the present disclosure, a capability of an algorithm in separating lung adenocarcinoma cells with the EGFR mutations and necrotic regions can be improved, so that it is less likely for a necrotic region to be mistakenly identified as EGFR-mutated lung adenocarcinoma cells after the lung adenocarcinoma cells having the EGFR mutations are visualized by the algorithm; the algorithm being one that visualizes the lung adenocarcinoma cells having the EGFR mutations according to a model trained by slide-level image computing.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for predicting epidermal growth factor receptor (EGFR) mutations in lung adenocarcinoma according to one embodiment of the present disclosure;

FIG. 2 is a schematic diagram showing a flow of the method for predicting the EGFR mutations in lung adenocarcinoma according to one embodiment of the present disclosure;

FIG. 3 is a receiver operating characteristic curve diagram of a trained deep learning model provided by one embodiment of the present disclosure;

FIG. 4 is another flowchart of a method for predicting epidermal growth factor receptor (EGFR) mutations in lung adenocarcinoma according to one embodiment of the present disclosure;

FIG. 5 is a flowchart of a method for generating a classification activation map according to one embodiment of the present disclosure; and

FIG. 6 is a visualization result obtained by applying the method for predicting EGFR mutations in lung adenocarcinoma of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

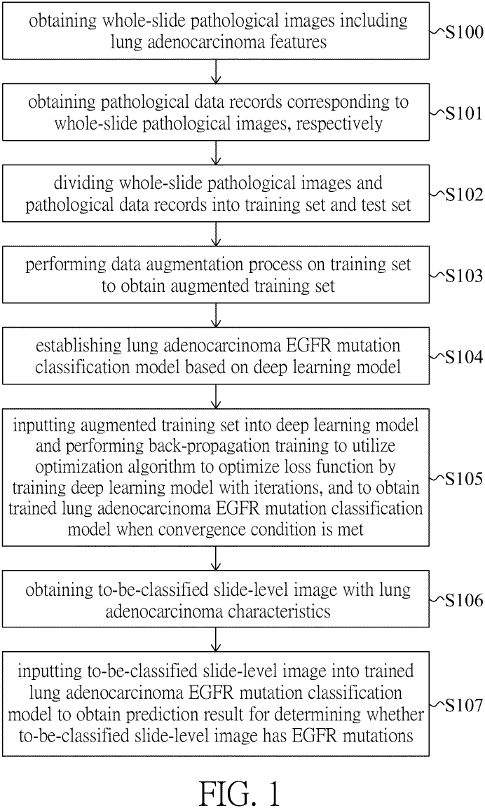

FIG. 1 is a flowchart of a method for predicting epidermal growth factor receptor (EGFR) mutations in lung adenocarcinoma according to one embodiment of the present disclosure. Referring to FIG. 1, one embodiment of the present disclosure provides a method for predicting epidermal growth factor receptor (EGFR) mutations in lung adenocarcinoma, the method is mainly performed at a slide-level, and a deep learning model and the method can be performed by a computer system at least including a memory and a processor.

Referring to FIG. 1, the method for predicting EGFR mutations in lung adenocarcinoma includes at least the following steps:

Step S100: obtaining a plurality of whole-slide pathological images including lung adenocarcinoma features.

Specifically, a first step in a training process of an artificial intelligence (AI) model is to obtain data. Clinically, after obtaining the patient’s lung samples, hematoxylin-eosin staining (H&E) and formalin-fixed wax embedding (FFPE) will be used to make pathological sections, and the diagnosis of lung adenocarcinoma will be performed by microscopy or digital pathology system.

Step S101: obtaining a plurality of pathological data records corresponding to the whole-slide pathological images, respectively. Specifically, the pathological data records respectively describe whether the corresponding whole-slide pathological images have EGFR mutations.

Based on the above steps, firstly, slides containing lung adenocarcinoma features are collected and converted into digital files using a pathological slide scanner, and the same slides are sent to a gene sequencing process to find out whether the lung adenocarcinomas have EGFR mutations. Specifically, one record of data includes one digital pathological image and corresponding pathological data record, which is used to show whether the pathological image has EGFR mutations. In one embodiment of the present disclosure, training data comes from a total of 1768 full slide images of lung adenocarcinoma pathological sections from the Taipei Medical University Hospital, Wanfang Hospital, and Shuanghe Hospital. After gene sequencings are performed, 1140 slides belong to patients with EGFR mutations, while the remaining 971 slides do not exhibit EGFR mutations.

Step S102: dividing the whole-slide pathological images and the pathological data records into a training set and a test set. In detail, the embodiments of the present disclosure utilize an annotation-free whole-slide training approach to train the AI model. In this step, all of the whole-slide pathological images are randomly shuffled, and resolutions of the whole-slide pathological image are reduced to a predetermined resolution. For example, an original whole-slide image size can be, for example, 40 times, with 200,000*200,000 pixels, and the predetermined resolution can be, for example, 10 times, with 40,000*40,000 pixels.

Step S103: performing a data augmentation process on the training set to obtain an augmented training set. Specifically, the data augmentation process includes randomly flipping, randomly shifting or randomly rotating the whole-slide pathological images of the training set to obtain the augmented training set.

Step S104: establishing a lung adenocarcinoma EGFR mutation classification model based on a deep learning model. The deep learning model includes a convolutional layer, a pooling layer, a normalization layer, a global pooling layer and a fully-connected Layer.

In detail, the lung adenocarcinoma EGFR mutation classification model is generated by training a convolutional neural network (CNN) with a whole-slide training method, and the trained deep learning model can be used to predict whether a pathological image that includes the lung adenocarcinoma features has EGFR mutations.

For example, the deep learning model based on the CNN mainly includes several stacked layers. When a slide-level pathological image is input, a first layer converts the image to obtain an intermediate feature map. Then, the second layer uses the previously generated feature map (not limited to the feature map generated by a previous layer) as an input and converts it into another feature map, and so forth. After all layers perform computations in turn, the last feature map is a result of the model predicting whether this slide contains lung adenocarcinoma cells with EGFR mutations.

According to operations of the layers, which can be divided into different types of layers, and common types include convolutional layers, pooling layers, normalization layers, global pooling layers and fully-connected layers.

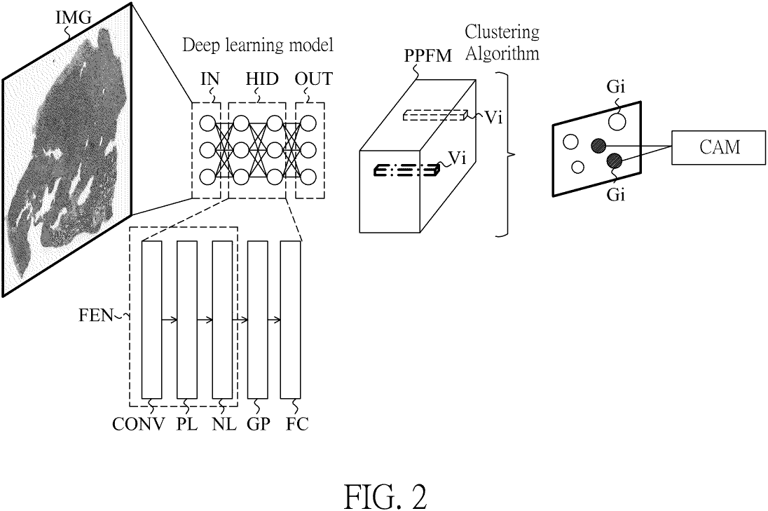

A deep learning model based on a convolutional neural network can be, for example, ResNet50 or ResNet152, both of which use a similar structure. Reference is made to FIG. 2, which is a schematic diagram showing a flow of the method for predicting the EGFR mutations in lung adenocarcinoma according to one embodiment of the present disclosure. As shown in FIG. 2, a deep learning model can include an input layer IN, multiple hidden layers HID and an output layer OUT, and the hidden layers HID can include a convolutional layer CONV, a pooling layer PL, a normalization layer NL, a global pooling layer GP and a fully connected layer FC. The convolutional layer CONV, the pooling layer PL, and the normalization layer NL, form a feature extraction network FEN.

Functionally, the feature extraction network FEN, which is formed by a multi-layer structure, firstly performs feature extractions on input pathological images. That is, types of cells and tissues are identified, and such information is retained in the output pre-pooling feature image, while unimportant features are discarded. The global pooling layer GP then integrates the features extracted from different positions in the image, that is, whether each of the features appears anywhere on this slide and whether they should be retained or discarded, such that relevant location information can be obtained after the unimportant features are discarded. The final fully connected layer FC then integrates the extracted features to obtain a final prediction result.

Functions performed by the global pooling layer GP and the fully connected layer FC in the deep learning model will first be described herein. The global pooling layer GP integrates features captured from different positions in the whole-slide pathological image. In other words, the global pooling layer GP reduces the size (i.e., H×W) of the pre-pooling feature map PPFM to generate a global pooling vector. The global pooling vector can be represented by:

$$E = G l o b a l P o o l \left(X\right) ;$$

where E is the global pooling vector that is a vector of size C, and each element indicates whether or not a certain feature appears in the to-be-classified slide-level image IMG.

On the other hand, the fully connected layer FC is used to perform a weighted sum operation on the global pooling vector, so as to generate an evaluation score. The evaluation score is used to indicate whether the to-be-classified slide-level image contains cancer cells, and can be represented by the following equation:

$$Z = W ⋅ E + b ;$$

where Z is the evaluation score and is a scalar, E is the global pooling vector, W is a first weight of the fully connected layer, and b is a second weight of the fully connected layer. W and b are learnable weights, which are determined during the training of the deep learning model and are used to control an importance of each feature.

Step S105: inputting the augmented training set into the deep learning model and performing a back-propagation training to utilize an optimization algorithm to optimize a loss function by training the deep learning model with a plurality of iterations, in which, when a convergence condition is met, a trained lung adenocarcinoma EGFR mutation classification model is obtained. For example, the deep learning model can be, for example, ResNet50 model or ResNet152 model, the loss function is a binary cross entropy, and the optimization algorithm is Adam algorithm.

In some embodiments that the convolutional neural network of ResNet50 is used, ResNet50 consists of five convolutional stacks, a global average pooling layer and a fully connected layer sequentially from input to output.

In addition, the five convolution stacks are named conv1, conv2, conv3, conv4, and conv5, respectively. The convolution stack conv1 is composed of a single-layered convolutional layer and a single-layered maximum pooling layer. The single-layer convolutional layer of the convolution stack conv1 has a kernel size of 7 × 7, a stride of 2 × 2, and output channels of 64, while the single-layer max-pooling layer of the convolution stack conv1 has a kernel size of 7 × 7 and a stride of 2 × 2.

Moreover, structures of the remaining convolution stacks conv2 to conv5 are similar, and are all composed of multiple convolutional blocks, the numbers of which are 3, 4, 6, and 3, respectively for the convolution stacks conv2 to conv5. Each of the convolutional blocks of the convolution stacks conv2 to conv5 includes five layers being, from output to input, one convolutional layer (having a kernel size of 1 × 1), one batch normalization layer, one convolutional layer (having a kernel size of 3 × 3), one batch normalization layer, and one convolutional layer (having a kernel size of 1 × 1). The numbers of output channels of the convolutional layers contained in the four convolutional stacks conv2 to conv5 are different. The numbers of the output channels of the first two convolutional layers in each convolutional block are 64 in the convolutional layer conv2, 128 in the convolutional layer conv3, 256 in the convolutional layer conv4, and 512 in the convolutional layer conv5. The numbers of the output channels of the third convolutional layer in each convolutional block are 256 in the convolutional layer conv2, 512 in the convolutional layer conv3, 1024 in the convolutional layer conv4, and 2048 in the convolutional layer conv5.

However, it should be noted that the above model parameters are only examples, and the present disclosure does not limit the number of convolution stacks of the convolutional neural network, the number of convolution layers in the convolution stack, and settings of kernel size, stride, and number of output channels.

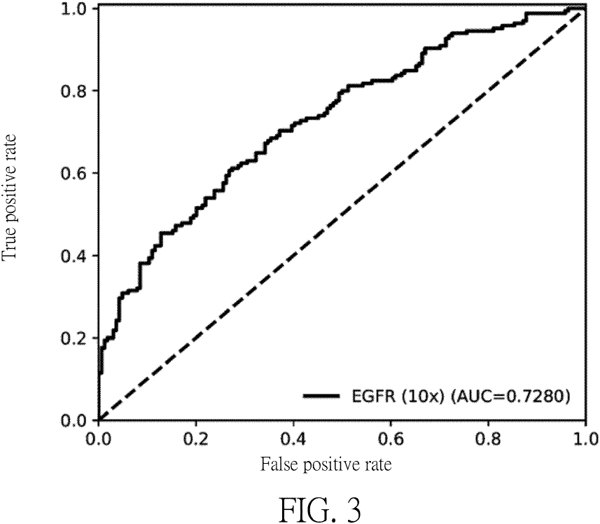

Reference is further made to FIG. 3, which is a receiver operating characteristic curve diagram of a trained deep learning model provided by one embodiment of the present disclosure. After the training is completed, performance of the model can be evaluated by using the aforementioned training set. For example, in this embodiment, the performance of the model can be evaluated by using lung adenocarcinoma pathological images that are not used for the model training, and a receiver operating characteristic (ROC) curve can be illustrated. In FIG. 3, a vertical axis represents a true positive rate, a horizontal axis represents a false positive rate, and an area under the curve (AUC) in predicting whether the lung adenocarcinoma has EGFR mutations can be obtained as 0.7284, and a 95% confidence interval can be obtained as 0.6747- 0.7821. Therefore, since the AUC is ranges from 0.7 to 0.8, it can be seen that there is a clear distinction for predicting whether or not lung adenocarcinoma has EGFR mutations.

Step S106: obtaining a to-be-classified slide-level image with lung adenocarcinoma characteristics.

Step S107: inputting the to-be-classified slide-level image into the trained lung adenocarcinoma EGFR mutation classification model to obtain a prediction result for determining whether the to-be-classified slide-level image has EGFR mutations.

Therefore, the present disclosure provides an AI screening system for predicting whether the pathological image of lung adenocarcinoma has EGFR mutations, which can help to provide an indicator that can predict whether lung adenocarcinoma has EGFR mutations in a clinical environment, so as to determine whether or not to recommend gene sequencing, and to assist doctors in accurately prescribing medication for lung adenocarcinoma with or without EGFR mutations.

In one embodiment of the present disclosure, visualization capability of the deep learning model for lung adenocarcinoma cells with EGFR can be further enhanced based on the above method.

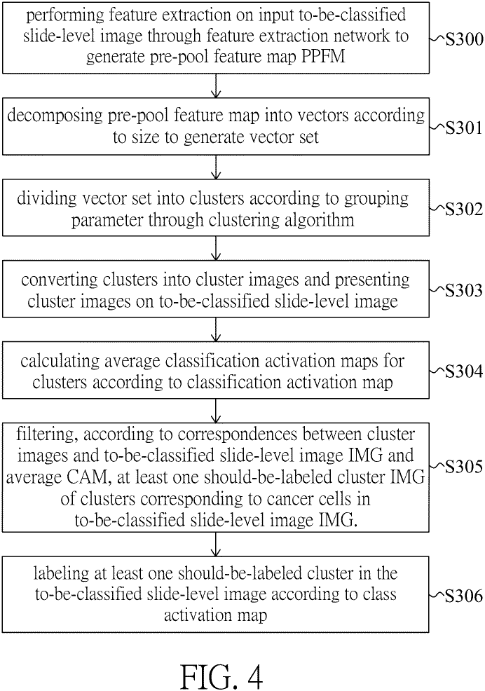

Reference is made to FIG. 4, which is another flowchart of a method for predicting epidermal growth factor receptor (EGFR) mutations in lung adenocarcinoma according to one embodiment of the present disclosure. For visualization of lung adenocarcinoma cells with EGFR, the method further includes the following steps:

Step S300: performing a feature extraction on the input to-be-classified slide-level image through the feature extraction network to generate a pre-pool feature map PPFM.

In detail, the pre-pool feature map can be represented by X_{hwc}, which is a tensor of size H × W × C, where H × W is a size of the tensor, and dimensions H and W correspond to a height and a width of the tensor, C is the number of a channel, which represents the maximum number of captured features.

In a preferred embodiment of the present disclosure, after ResNet50 is trained with pathological images with a size of 4X, the pre-pool feature map PPFM with a size of 625(H)*625(W)*2048(C) can be obtained. In addition, in other embodiments, ResNet152 can be directly trained with pathological images with a size of 40X, and the pre-pool feature map PPFM with a size of 6250(H)*6250(W)*2048(C) can be obtained.

The pre-pool feature map PPFM includes a plurality of elements X_{hwc}, and each of the elements X_{hwc}is used to indicate whether one of a plurality of features appears in one of a plurality of positions (for example, coordinates h, w) in the to-be-classified slide-level image IMG. The larger a value of the element X_{hwc}, the more obvious the feature corresponding to the element X_{hwc}.

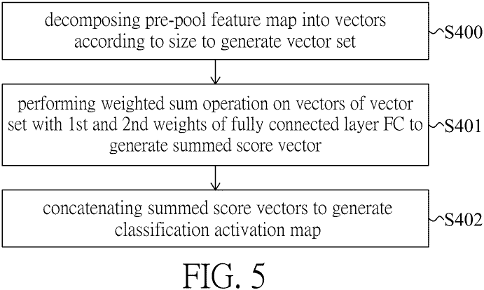

In the above deep learning model, a class activation map (CAM) can be generated to represent probabilities of cancer being determined from the to-be-classified slide-level image IMG. Reference is made to FIG. 5, which is a flowchart of a method for generating a classification activation map according to one embodiment of the present disclosure.

Step S400: decomposing the pre-pool feature map into a plurality of vectors Vi according to the size (H × W) to generate a vector set. The vector set can be represented as {E′_{ihw}|i ∈ T, hw ∈ H × W}, and each of the vectors has a plurality of channel units corresponding to the features.

Step S401: performing the weighted sum operation on the vectors of the vector set with the first weight and the second weight of the fully connected layer FC to generate a summed score vector, which is represented by the following equation:

$${{\text{Z}}^{′}}_{\text{hw}} = \text{W} ⋅ {{\text{E}}^{′}}_{\text{hw}} + \text{b;}$$

where Z′_{hw} is the summed score vector, E′_{hw} is the vector set, W is the first weight, and b is the second weight.

Step S402: concatenating the summed score vectors to generate a classification activation map. The CAM is a two-dimensional tensor having the size H × W, and a value of each position in the CAM represents a corresponding probability of determining that the lung adenocarcinoma cells have the EGFR mutations in the pre-pool feature map. In the present disclosure, a magnitude of a value at each position in the generated classification activation map is further utilized to assist in marking areas of the lung adenocarcinoma cell with EGFR mutations.

As a strong classifier, the deep learning model strives to capture all information in the training data. Therefore, when distinguishing whether or not the lung adenocarcinoma cells have EGFR mutations, in addition to types of cancer cells with EGFR mutations that need to be learned and captured by the deep learning model, necrosis and desmoplasia that are often accompanied by the cancer cells may be recognized by the deep learning model to serve as “suspected cancer”, which causes such areas to be marked in the CAM.

In fact, in the deep learning model trained with a slide-level training set, features such as lung adenocarcinoma cells with EGFR mutations, necrosis, and desmoplasia are represented by the model as different channels in the pre-pool feature maps, respectively. That is, some channels on the pre-pool feature map identify lung adenocarcinoma cells with EGFR mutations, and others identify necrosis and desmoplasia. However, in the above-mentioned process of generating CAM, after these values are weighted and summed to generate the final prediction result, it is not possible to identify, according to a single number, whether a condition of numerical bias is caused by an identification of lung adenocarcinoma cells with EGFR mutations or necrosis.

Therefore, in the present disclosure, cancer cell features of lung adenocarcinoma cells with EGFR mutations are separated from other accompanying features based on the above premises, that is, channels that are used to identify lung adenocarcinoma cells with EGFR mutations are obtained by analyzing a distribution of each vector in the pre-pool feature map.

The vectors in the vector set corresponding to the lung adenocarcinoma cells with EGFR mutations have low intra-class dissimilarity, since the features of cancer cells cause the channels for extracting cancer cell features to have high values, while other channels have very low values. Any distance evaluation method, such as those involving Euclidian distance and cosine similarity, can be used to obtained the lower values. On the contrary, the vectors in the vector set corresponding to the cancer cell region and the necrotic region have high intra-class dissimilarity therebetween, since the two types of regions activate different channels.

With such characteristics, the vectors of lung adenocarcinoma cells with EGFR mutations and necrotic regions can be divided into different clusters by using a clustering algorithm, so as to separate the lung adenocarcinomas with EGFR mutations from the necrotic regions.

Reference is made to FIG. 4 again, where the method now proceeds to Step S301: decomposing the pre-pool feature map into a plurality of vectors Vi according to the size (H×W) to generate a vector set. This step is similar to step S400, and details thereof will not be repeated herein.

Step S302: dividing the vector set into a plurality of clusters according to a grouping parameter through a clustering algorithm. The clustering algorithm can be, for example, k-means algorithm, and Euclidean distance can be utilized as a criterion for estimating dissimilarity. In one embodiment of the present disclosure, a clustering parameter can be, for example, the number of the clusters, such as k (k=5 can be set). A value of k needs to be adjusted manually. In principle, as long as k is large enough, cancer cells and other types of cells can be separated. If the value of k is too large, the lung adenocarcinoma cells with EGFR mutation may be divided into two or more groups. In an exemplary embodiment of the present disclosure, the size of k is 5, k is a positive integer, and can range from 3 to 7, but the present disclosure is not limited thereto. However, in a case where k is greater than or equal to 2, the k-means algorithm can still be utilized.

Step S303: converting the clusters into a plurality of cluster images and presenting the cluster images on the to-be-classified slide-level image. As previously described, since too large a k value may divide the cancer cell regions into two or more clusters, regions within each cluster can be presented on the original image, and the final manual review can be used to confirm which of clusters of lung adenocarcinoma cells with EGFR mutation should be marked. The clusters that are identified as lung adenocarcinoma cells with EGFR mutation should be marked according to the corresponding positions of the original slide image.

Step S304: calculating a plurality of average classification activation maps for the clusters according to the classification activation map.

Step S305: filtering, according to correspondences between the cluster images and the to-be-classified slide-level image IMG and an average CAM, at least one to-be-labeled cluster IMG of the clusters corresponding to cancer cells in the to-be-classified slide-level image IMG.

Step S306: labeling the at least one to-be-labeled cluster in the to-be-classified slide-level image according to a class activation map (CAM).

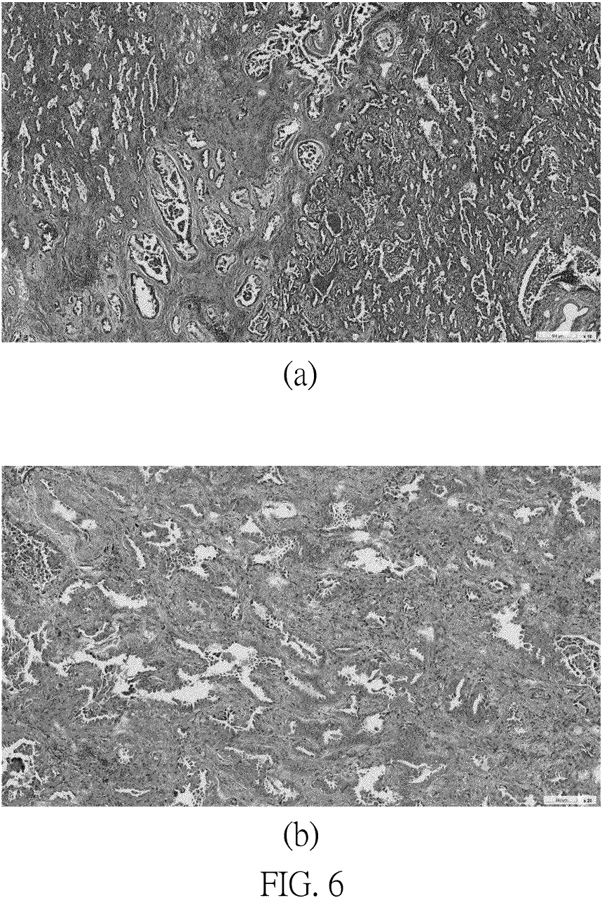

Reference is made to FIG. 6, which is a visualization result obtained by applying the method for predicting EGFR mutations in lung adenocarcinoma of the present disclosure. Parts (a) and (b) of FIG. 6 are the CAM visualization results of the present disclosure. As shown in FIG. 6, the method for predicting EGFR mutations in lung adenocarcinoma of the present disclosure can clearly indicate whether the lung adenocarcinoma has EGFR mutations.

### Beneficial Effects of the Embodiments

In conclusion, in the method for predicting epidermal growth factor receptor mutations in lung adenocarcinoma provided by the present disclosure, an indicator that can predict whether EGFR mutations are present or absent in lung adenocarcinoma is provided, such as to allow for a more accurate opinion on whether or not to perform gene sequencing, thus saving resources and improving sensitivity.

Moreover, in the method for predicting the EGFR mutations in lung adenocarcinoma provided by the present disclosure, a capability of an algorithm in separating lung adenocarcinoma cells with the EGFR mutations and necrotic regions can be improved, so that it is less likely for a necrotic region to be mistakenly identified as EGFR-mutated lung adenocarcinoma cells after the lung adenocarcinoma cells having the EGFR mutations are visualized by the algorithm; the algorithm being one that visualizes the lung adenocarcinoma cells having the EGFR mutations according to a model trained by slide-level image computing.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for predicting epidermal growth factor receptor (EGFR) mutations in lung adenocarcinoma, comprising:
obtaining a plurality of whole-slide pathological images, each including lung adenocarcinoma features;
obtaining a plurality of pathological data records corresponding to the whole-slide pathological images, respectively, wherein the pathological data records respectively describe whether the corresponding whole-slide pathological images have EGFR mutations;
dividing the whole-slide pathological images and the pathological data records into a training set and a test set;
performing a data augmentation process on the training set to obtain an augmented training set;
establishing a lung adenocarcinoma EGFR mutation classification model based on a deep learning model, wherein the deep learning model includes a convolutional layer, a pooling layer, a normalization layer, a global pooling layer and a fully-connected layer;
inputting the augmented training set into the deep learning model and performing a back-propagation training to utilize an optimization algorithm to optimize a loss function by training the deep learning model with a plurality of iterations, wherein, when a convergence condition is met, a trained lung adenocarcinoma EGFR mutation classification model is obtained;
obtaining a to-be-classified slide-level image including lung adenocarcinoma features; and
inputting the to-be-classified slide-level image into the trained lung adenocarcinoma EGFR mutation classification model to obtain a prediction result for determining whether the to-be-classified slide-level image has EGFR mutations.

2. The method according to claim 1, wherein the data augmentation process includes randomly flipping, randomly shifting or randomly rotating the whole-slide pathological images of the training set to obtain the augmented training set.

3. The method according to claim 1, further comprising: randomly shuffling the whole-slide pathological images, and reducing a resolution of the whole-slide pathological images to a predetermined resolution.

4. The method according to claim 1, wherein the deep learning model is a ResNet50 model or a ResNet152 model.

5. The method according to claim 1, wherein the loss function is binary cross entropy.

6. The method according to claim 1, wherein the optimization algorithm is an Adam algorithm.

7. The method according to claim 1, wherein the convolutional layer, the pooling layer and the normalization layer form a feature extraction network.

8. The method according to claim 7, further comprising:
performing a feature extraction on the input to-be-classified slide-level image through the feature extraction network to generate a pre-pool feature map, wherein the pre-pool feature map includes a plurality of elements, each of the elements is used to indicate whether one of a plurality of features appears on one of a plurality of positions in the to-be-classified slide-level image;
decomposing the pre-pool feature map into a plurality of vectors according to a size to generate a vector set, wherein each of the vectors has a plurality of channel units corresponding to the features;
dividing the vector set into a plurality of clusters according to a grouping parameter through a clustering algorithm;
converting the clusters into a plurality of cluster images and presenting the cluster images on the to-be-classified slide-level image;
filtering, according to correspondences between the cluster images and the to-be-classified slide-level image, at least one to-be-labeled cluster of the clusters corresponding to cancer cells in the to-be-classified slide-level image; and
labeling the at least one to-be-labeled cluster in the to-be-classified slide-level image according to a class activation map (CAM).

9. The method of claim 8, wherein the pre-pool feature map is a tensor of size HxWxC, where HxW is the size and corresponds to a height and a width of the tensor, C is a quantity of channels, and H and W are dimensions corresponding to a height and a width of the to-be-classified slide-level image, respectively.

10. The method according to claim 8, further comprising:
reducing the size of the pre-pool feature map through the global pooling layer to generate a global pooling vector; and
performing a weighted sum operation on the global pooling vector through the fully connected layer to generate an evaluation score,
wherein the evaluation score is used to indicate whether the to-be-classified slide-level image contains cancer cells, and is represented by a following equation:
$$\text{Z = W} ⋅ \text{E + b,}$$
where Z is the evaluation score and is a scalar, E is the global pooling vector, W is a first weight of the fully connected layer, and b is a second weight of the fully connected layer.

11. The method according to claim 8, further comprising:
performing the weighted sum operation on the vectors of the vector set with the first weight and the second weight of the fully connected layer to generate a summed score vector, which is represented by a following equation:
$${{\text{Z}}^{′}}_{\text{hw}} \text{= W} ⋅ {{\text{E}}^{′}}_{\text{hw}} \text{+ b} \text{,}$$
where Z′
_{hw} is the summed score vector, E′_{hw} is the vector set, W is the first weight of the fully connected layer, and b is the second weight of the fully connected layer; and
splicing the summed score vector to generate the CAM, wherein the CAM is a two-dimensional tensor having the size, and a value of each position in the CAM represents a corresponding probability of determining that the lung adenocarcinoma cells have the EGFR mutations in the pre-pool feature map.

12. The method according to claim 8, further comprising:
calculating a plurality of average classification activation maps for the clusters according to the classification activation map; and
filtering, according to correspondences between the cluster images and the to-be-classified slide-level image and the average classification activation maps, the at least one to-be-labeled cluster of the clusters.

13. The method according to claim 8, wherein the clustering algorithm is a k-means algorithm.

14. The method according to claim 13, wherein the k-means algorithm uses Euclidean distance as a criterion for evaluating distances, and the clustering parameter is a quantity of the clusters.
